(19) United States
(12) Patent Application Publication
(10) Pub. No.: US 2004/0024697 A1
(43) Pub. Date: Feb. 5, 2004

(54) Method and system for transferring money

(76) Inventors: Pedro Enrique Landa, Austin, TX (US); Pedro Esteban Kaufmann, Austin, TX (US)

Correspondence Address: HUGHES & LUCE LLP, 1717 MAIN STREET, SUITE 2800, DALLAS, TX, 75201, US

(21) Appl. No.: 10/205,277

(22) Filed: Jul. 24, 2002

(51) Int. Cl. G06F 17/60

(52) U.S. Cl. 705/39; 705/41

(57) ABSTRACT

The invention is directed to a method and system for transferring money between parties. A purchaser buys a card with a unique identification code and associated denomination of currency from a vendor. The vendor provides a verification code to the purchaser. The purchaser then may contact or call a service provider and provide the unique identification code, the verification code, and information about the recipient. The service provider may then provide conversion and/or exchange data. The purchaser may then inform the recipient of the transaction and provide to the recipient the data associated with the transaction. The recipient may go to a distributor and receive currency or credit. The information about the recipient may be used to verify the identity of the recipient before distribution of money or credit.

### TECHNICAL FIELD OF INVENTION

This invention relates to the transfer of money between locations. More specifically, this invention relates to the transfer of money or lines of credit using a set of verification numbers and recipient information.

### BACKGROUND OF THE INVENTION

Annually, billions of dollars are transferred around the globe. According to the World Bank, remittances to Latin America and the Caribbean totaled over $15 billion a year in 2000, ten times more than in 1980. These remittances total more than the foreign aid provided to these countries.

In part, the cause of the large remittance totals is a result of immigration from countries suffering from poverty or political turmoil. Immigrants have moved from many countries in the Caribbean and Latin America to North America and Western Europe. Some 15 million people born in Latin America have now settled in the United States-half the country's immigrants-while 18% of the foreigners in Spain are from Latin America. The Inter-American Development Bank estimates that at least $300 billion will be sent home over the next ten years.

However, Latin America and the Caribbean are also frequented vacation locations. Many North Americans and Europeans frequent the beaches and tropical climates of countries such as Mexico, Jamaica, Cuba, Belize, and Brazil.

Furthermore, these countries are slowly emerging as sources for labor and commerce. Mexico, Brazil, Chile, and Argentina have seen large economic growth in the past 20 years and will likely grow further in the future.

However, the location of these recipients may be remote and may not have access to global interconnected networks and computer technology. Many typical methods of transfer require complex computer systems or access to global interconnected networks. Furthermore, these remote locations may have limited numbers of trained technical personnel to establish and use the complex computer systems. In addition, transfer costs and often lousy exchange rates account for about 15% of the money remitted to the region. Moreover, many typical solutions do not guarantee the transfer.

Some individuals attempt to send currency or money orders through the mail system. While this method avoids the bank fees, the money is often lost, stolen, or does not reach the intended part.

Other typical solutions involve complicated computer networks, banking systems, and wire transfers. These are often associated with costly fees and unfair exchange rates.

As such, many typical money transfer solutions suffer from deficiencies in providing economic and technically feasible transfer solutions. Many other problems and disadvantages of the prior art will become apparent to one skilled in the art after comparing such prior art with the present invention as described herein.

### SUMMARY OF THE INVENTION

Aspects of the invention may be found in a method of transferring money between people. In the method, a service provider and/or an associated vendor may sell to a purchaser a card. The card may have an associated monetary value and a unique identification number. Further, the vendor or service provider may generate and provide a verification code to the purchaser. The purchaser may then contact the service provider and provide information about the recipient. This information may include information about the recipient and how to verify the identity of the recipient. Further, the service provider may inform the purchaser of the exchange rate and/or the final distribution amount. For example, the purchaser may call a phone number, enter the verification number and unique card number, and leave a voice message regarding the identity and verification information. A recipient may then go to a distributor and present verification of his/her identity. The distributor may contact the service provider, receive the recipient data, and a transfer amount. The distributor may then provide currency or a line of credit to the recipient.

Further aspects of the invention may be found in the service provider collecting money from the vendor in an amount associated with the card. This amount may be less any fees or commissions associated with the vending transaction. The service provider and vendor may track transactions with the verification number.

Additional aspects of the invention may be found in the service provider providing to the distributor an amount associated with the card. This amount may include additional fees or commissions associated with the distribution transaction. The service provider may also provide a means of contacting and verifying card and recipient information.

Aspects of the invention may also be found in a system for transferring money. The system may include a card with a unique identification number, a verification number, a service provider system, and a distributor. The service provider system may collect the unique identification number and verification number from a purchaser. Further, the service provider may collect information associated with verifying the identity of the recipient. The distributor may then contact the service provider, verify the identity and transfer amount, and distribute the currency or line of credit.

The currency of the denomination associated with the card and the currency of distribution may be the same or different or include other means of facilitating trade. The verification number may be generated from data associated with the date of the vending, the vendor identity, the vending location, the card number, and the denomination, among others.

As such, a system for transferring money is described. Other aspects, advantages and novel features of the present invention will become apparent from the detailed description of the invention when considered in conjunction with the accompanying drawings.

### BRIEF DESCRIPTION OF DRAWINGS

For a more complete understanding of the present invention and advantages thereof, reference is now made to the following description taken in conjunction with the accompanying drawings in which like reference numbers indicate like features and wherein:

FIG. 1 is a schematic block diagram depicting the system according to the invention;

FIG. 2A is a block diagram of an exemplary embodiment of a front of a card for use by the system as seen in FIG. 1;

FIG. 2B is a block diagram of an exemplary embodiment of a back of a card for use by the system as seen in FIG. 1;

FIG. 3 is a block diagram of an exemplary embodiment of a receipt for use by the system as seen in FIG. 1;

FIG. 4 is a block flow diagram of an exemplary method for use in the system as seen in FIG. 1;

FIG. 5 is a block flow diagram of an exemplary method for use in the system as seen in FIG. 1;

FIG. 6 is a block flow diagram of an exemplary method for use in the system as seen in FIG. 1;

FIG. 7 is a block flow diagram of an exemplary method for use in the system as seen in FIG. 1;

FIG. 8 is a block diagram of an exemplary embodiment of a provider system as seen in FIG. 1;

FIG. 9 is a block diagram of an exemplary embodiment of a vendor system as seen in FIG. 1; and

FIG. 10 is a schematic block diagram of an exemplary embodiment of the system as seen in FIG. 1.

Corresponding reference numerals indicate corresponding parts throughout the several views of the drawings.

### DETAILED DESCRIPTION OF THE INVENTION

Billions of dollars are transferred across borders, continents and oceans. Money may also be transferred within countries. Often money or credit is transferred to a relative, stranded traveler, or business associate. The present invention relates to a method and system for inexpensively and effectively facilitating that transfer.

FIG. 1 is a schematic block diagram depicting the system according to the invention. The system 10 includes a vendor 14, a provider 16, and a distributor 18. However, there may be more than one vendor 14, provider 16, and distributor 18. Further, these parties may be together, separate or in combination, among others.

The vendor 14 may vend a card with an associated denomination of currency to a purchaser 12. In addition, the vendor 14 may provide a verification number. The purchaser 12 may then contact the provider 16. The purchaser 12 may provide the service provider 16 with the unique identification number, the verification number, and information associated with the recipient 20.

The purchaser 12 may then contact the recipient 20 and provide data associated with the transaction to the recipient 20. The recipient 20 may retrieve the money, exchanged currency, or line of credit from the distributor 18. The distributor 18 may contact the provider 16 to verify the transaction and retrieve the recipient information. The distributor 18 may use the recipient information to verify the identity of the recipient 20.

Further, the verification number provided by the vendor 14 may have characteristics indicative of the vendor 14 identity, vendor location, denomination of the transaction, unique identification number, and date, among others. With this information, the service provider 16 may track transactions and collect transferred money from the vendor 14.

With this system 10, money may be transferred and or exchanged between locations. Further, the system and associated methods are inexpensive and secure. The system and method may be used without complex computer equipment or access to global interconnected networks at the distribution site.

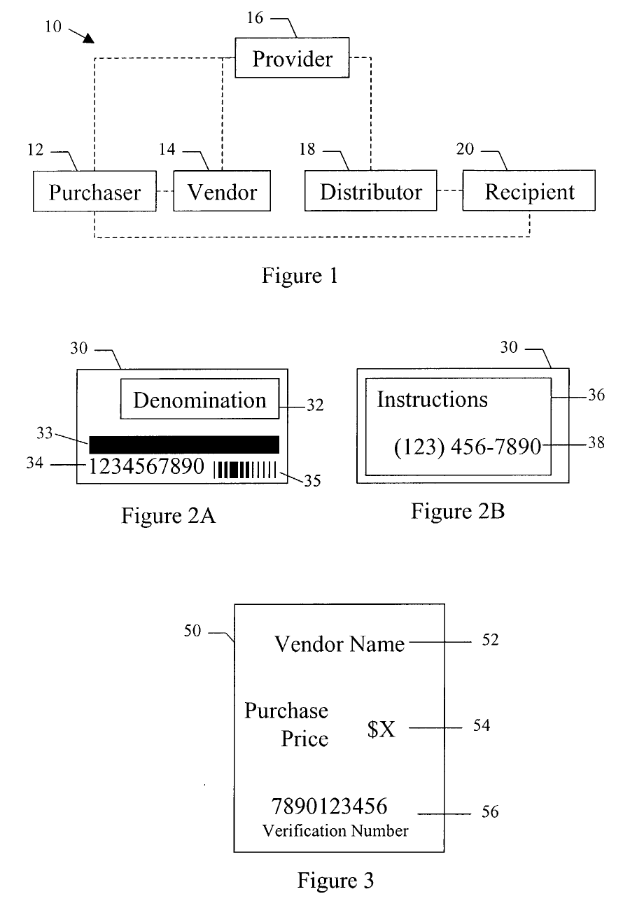

FIGS. 2A and 2B are block diagrams depicting an exemplary embodiment of a card 30 for use in the system as seen in FIG. 1. The card may or may not be disposable. FIG. 2A depicts a front side of the card 30 having a denomination 32, magnetic strip 33, unique identification number 34, and bar code 35. FIG. 2B depicts a back side of the card 30 having instructions 36 and a phone number 38. However, various embodiments of the card may be envisaged and the card may or may not have a denomination 32, instructions 36, phone number 38, magnetic strips 33, and bar codes 35 among others.

The denomination 32 may depict a monetary amount in a first currency. For international transfers this monetary amount may be expressed in the currency of the vending transaction. However, the monetary amount may also be expressed in the distribution currency, a standard currency, or any monetary equivalent, among others.

The unique identification number 34 may uniquely identify the card. The identification number 34 may also be indicative of the monetary amount, a date of manufacture, other manufacture characteristics, and card vending characteristics, among others. However, the unique identification number 34 may or may not be indicative of these data. Further, the unique identification number 34 may be provided in the form of a bar code 35 and/or magnetic strip 33. In this manner, the identification of the card 30 may be easily entered into a vending system.

The instruction 36 may direct a purchaser to call a phone number 38. However, the instructions 36 may indicate other means for contacting the service provider. These means may include the website, fax number, and email address, among others.

The vendor may provide a verification number to the purchaser. The verification number may be indicative of a completion of the vending transaction. For example, the verification number may be provided on a receipt. FIG. 3 depicts an exemplary embodiment of a receipt for use in the system as seen in FIG. 1. The receipt 50 may have a vendor name 52, purchase price 54 and verification number 56. However, various embodiments of the receipt may be envisaged and the receipt may or may not have a vendor name 52, purchase price 54, or verification number 56. Further, various other means of providing a verification number may be envisaged.

The verification number 56 may be calculated or preset. Further, the verification number 56 may have characteristics indicative of the completed transaction, the vendor, the date of vending, the card unique identification number, the denomination associated with the card, and the vendor location, among others. In this manner, the verification number 56 may be used to insure that the card was bought, not stolen, and that the vendor is in possession of the monetary amount. Further, the service provider may track the transactions and retrieve the monetary amount from the vendor less any fees and/or commissions.

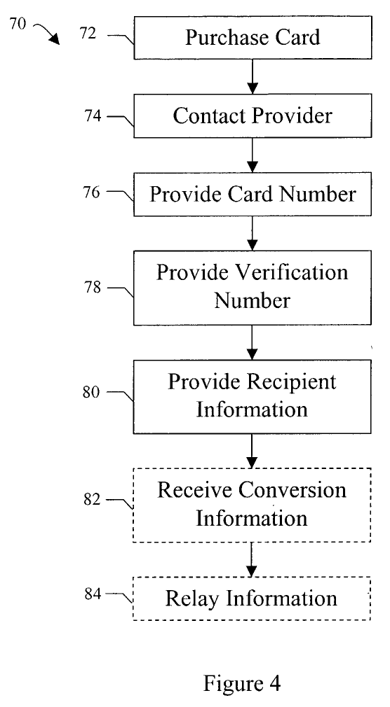

FIG. 4 is a block flow diagram depicting a method for transferring money as seen in the system of FIG. 1. In the method 70, a purchaser may purchase a card with a unique identification number from a vendor as seen in a block 72. The vendor may provide the purchaser with a verification number indicative of a complete transaction.

The purchaser may then contact the service provider as seen in a block 74. This contact may be through a telephone. Alternately, the purchaser may contact the provider through other means including a website, email, or facsimile, among others.

In contacting the service provider, the purchaser may provide the unique identification number and the verification number as seen in the blocks 76 and 78. These numbers may suffice to inform the service provider of the transaction information and confirm the sale of the card and exchange of monetary amounts. Further, the service provider may use personnel or an automated means of receiving the information. For example, a service representative may answer the phone. Alternately, an automated system may interact with the client through a menu driven system or through various voice recognition technologies.

In addition, the purchaser may provide information associated with the recipient as seen in a block 80. The information may include a means of identifying the recipient such as a name, a drivers license number, passport number, birth certificate, address, code number, or password, among others. For example, the purchaser may provide, through a menu driven system, a touch tone signal indicating a drivers license number. Alternately, the purchaser may leave a voice message indicating the type of identification and/or the name of the recipient. However, various means of providing recipient information may be envisaged.

Further, the service provider may or may not provide conversion information to the purchaser as seen in a block 82. This conversion information may include an amount to be distributed to the recipient. Alternately, the conversion information may include information about currency exchange rates, locations of distributors, and instructions, among others.

The purchaser may or may not then relay the information about the transaction to the recipient as seen in a block 84. For example, the purchaser may call the recipient by telephone and provide them with the card number and instructions for receiving the money. Alternately, the purchaser may use other means to contact the recipient such as email, paging, or a letter, among others.

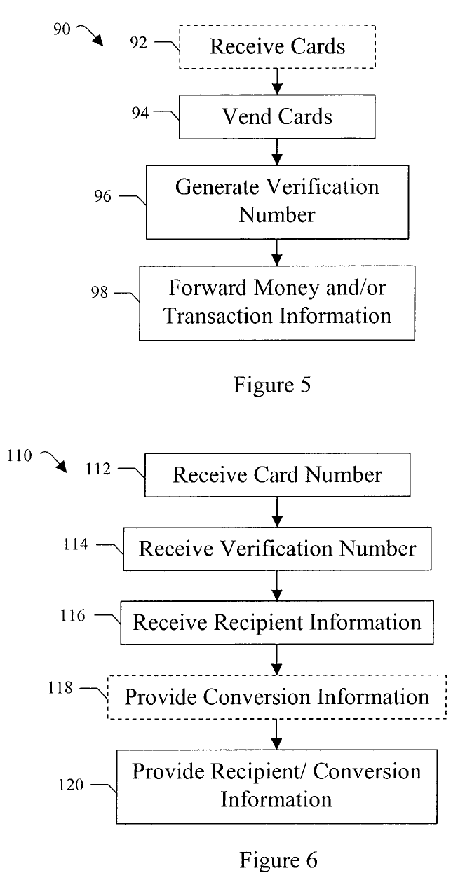

Turning to FIG. 5, the vendor may or may not receive cards from the service provider as seen in a block 92. The vendor may then sell the cards to purchasers as seen in a block 94. These cards may have unique identification numbers.

Further, the vendor may generate and provide the verification number to the purchaser as seen in a block 96. This verification number may be calculated or preset. Further, the verification number may have characteristics indicative of the completed transaction, the vendor, the date of vending, the card unique identification number, the denomination associated with the card, and the vendor location, among others. In this manner, the verification number may be used to insure that the card was bought, not stolen, and that the vendor is in possession of the monetary amount.

Further, the service provider may track the transactions and retrieve the monetary amount from the vendor less any fees and/or commissions. The vendor may forward, send, or transfer the monetary amount and/or transaction information to the service provider as seen in a block 98. This transfer may be through check, bank transfer, and lines of credit, among others. Further any transaction information may be transferred electronically, verbally, in writing, or through other means.

FIG. 6 depicts a method from the perspective of the service provider. In the method 110, the service provider may receive from the purchaser the card number, the verification number, and the recipient information as seen in the blocks 112, 114, and 116, respectively. This information may be transferred through the telephone. However various means may be used to contact the service provider.

For example, the purchaser may contact the service provider through the telephone. The purchaser may be guided through a menu system, provide card and verification numbers through a touch tone or voice recognition system, and provide or select a means of identifying the recipient or leave a voice recording indicating the identity of the recipient. However, various methods of providing the information may be envisaged.

The service provider may then provide conversion information to the purchaser as seen in a block 118. This conversion information may include an amount in exchanged currency associated with the denomination indicated by the card Further, information may be provided as to locations for receiving distribution, exchange rates, and further instructions, among others.

Subsequently, the service provider may provide conversion and recipient information to the distributor as seen in a block 120. For example, the distributor may call via telephone the service provider, enter the card number, and listen to the recipient information. However, various other means of contacting the service provider may be envisaged.

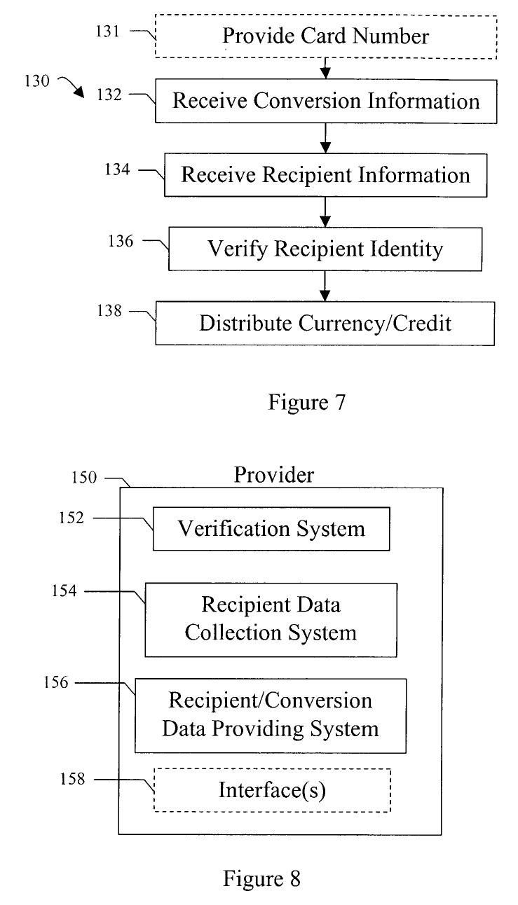

FIG. 7 is a block flow diagram indicating the method for use by the distributor. In the method 130, the distributor may contact the service provider and provide the card number as seen in a block 131. With the card number, the service provider can provide the conversion information and recipient information as seen in the blocks 132 and 134.

With this information, the distributor may verify the identity of the recipient as seen in a block 136. Then, the distributor may provide the currency or a line of credit as seen in a block 138. For example, the distributor may give the recipient a monetary amount in the currency of the location. Alternately, if the distributor were a store or supplier, the distributor may provide a line of credit or a combination of the currency and credit.

Turning to FIG. 8, the provider may have an automated system for receiving and providing information. The system 150 may have a verification system 152, a recipient data collection system 154, a recipient/conversion data providing system 156, and one or more interfaces 158. These elements and components may or may not be include, together, separately, or in various combinations, among others. Further these elements may be located remotely from one another and communicate through various means.

The verification system 152 may accept the unique card identification number and the verification number and determine the validity of the card and transaction. Further, the verification system 152 may determine the vendor information, transaction amounts, and exchange calculations.

The recipient data collection system 154 may provide a means for providing the identity of the recipient and a means for verifying the identity of the recipient. For example, recipient collection system 154 may provide options for providing a name, a drivers license number, passport number, birth certificate, address, code number, or password, among others. This information may or may not be provided though a touch tone phone, voice mail, or a website, among others. Further, the system 150 may permit the indication of a country or region in which the recipient will collect the money. This data may also be used in conjunction with the recipient/conversion data providing system.

The recipient/conversion data providing system 156 may include a means of delivering data associated with the transaction to the purchaser or the distributor. For example, the conversion and recipient information may be provided to the distributor through a telephone. The distributor may call the automated system 150 or the recipient/conversion data providing system 156 and listen to the conversion information and/or the recipient information. The distributor may then use this information in verifying the identity of the recipient and providing currency or a line of credit.

The interfaces 158 may include various means of communicating with the system 150 or for communicating between remotely located parts of the system 150. For example, one set of interfaces may include a menu driven telephone system for interacting with the purchaser and/or distributor. Alternately, the interface may include a network interface for communication between remotely located parts or a website for interaction with purchasers. However, various means of communication and interfaces may be envisaged.

For example, the system 150 may take the form of a server, set of servers, computerized phone system, or a combination, among others. However, various forms may be envisaged.

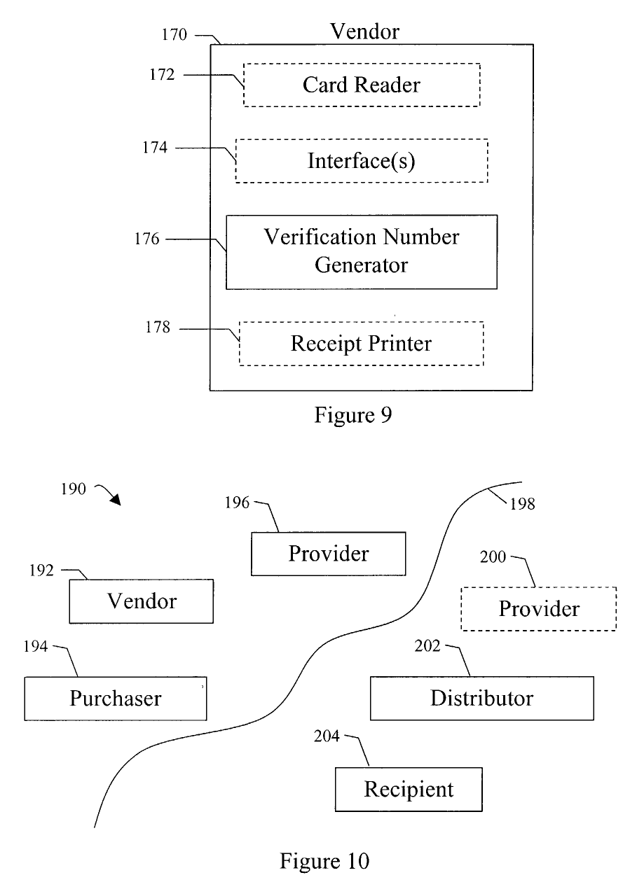

Turning to FIG. 9, the vendor may also have a system for vending. The system 170 may have a card reader 172, interfaces 174, a verification number or code generator 176, and a receipt printer 178, among others. However, these components may or may not be included and may or may not be together, separate, or in various combinations, among others.

The card reader 172 may take various forms. These forms may include a scanner, a magnetic strip reader, a character recognition reader, or a manual entry interface, among others.

The interfaces 174 may take various forms. These forms may include network interfaces, human interaction interface, and software interfaces, among others. The interfaces 174 may facilitate interaction between an operator of the system 170, remotely located units, and the various components, among others.

The verification number generator 176 may take various forms. These forms may include software and hardware generators. The verification number generator 176 may function to generate a verification number or code to verify the completion of the purchase of a card and may further serve to track transactions and identify the vendor. The verification number may be preset, randomly generated, or generated to include encoded data such as vendor location, vendor identity, date of sale, denomination of currency, and the card number, among others.

The receipt printer 178 may take various forms. These forms may include a printer for printing paper receipt and a printer for printing a verification number on a paper or the card, among others. The receipt printer 178 may function to provide the purchaser with a copy of the verification number or code.

For example, the vendor system 170 may take the form of a computer, register, stand-alone unit, or combination, among others. However, various forms may be envisaged.

FIG. 10 depicts an exemplary embodiment of the system as seen in FIG. 1. The exemplary system 190 has a purchaser 194, a vendor 192, one or more providers 196, a distributor 202, and a recipient 204. However, there may be many purchasers 194, vendors 192, providers 196, distributors 202, and recipients 204. Further, these components may be together, separate, or in various combinations.

The purchaser 194 may purchase a card from a vendor 192. The vendor 192 may provide a verification number to the purchaser 194. The purchaser 194 may then call the provider 196 or 200 and supply the card number, the verification number, and information about the recipient. For example, the purchaser 194 may contact by touch tone phone a provider system 196 with a menu driven means for entering the card number and verification number. The provider system 196 may the record a voice recording of the purchaser 194 providing the name of the recipient 204 and/or instructions on how to verify the identity of the recipient 204. Furthermore, the provider system may permit the purchaser 194 to indicate a country or currency for exchange purposes. The provider system 196 may then provide the purchaser 194 with a information associated with the exchange such as conversion rates, an exchange amount, or information about locations of distributors 202.

The purchaser 194 may then contact the recipient 204. For example, the purchaser 194 may send a letter to the recipient 204 or call by telephone the recipient 204. The purchaser 194 may provide the card number and/or the verification number to the recipient 204. The recipient 204 may then request the exchanged or transferred money or line of credit from the distributor 202.

The distributor 202 may then contact the provider 200 or 196. For example, the provider 200 may be a local or regional contact point or the provider 196 may be a unified contact point. However, various numbers, locations, and configurations of providers 196 and 200 may be envisaged. The distributor 202 may contact the provider 200 by telephone and, through a menu driven touch tone or voice recognition means enter the card number and listen to the identity of the recipient 204.

The distributor 202 may then provide an exchanged currency to the recipient 204. Alternately, the distributor 202 may provide a line of credit. The line of credit or currency may be in a different currency than that used in the card purchase. Further, the amount of the line of credit or currency may be adapted for fees, commissions, and exchange rates.

Further, the provider 196 or 200 may receive money from the vendor 192. The provider 196 may use the verification number to track transactions. The vendor may provide money associated with the transaction less fees and commissions. The provider 196 or 200 may then provide money to the distributor. The money may be the amount distributed plus any fees or commissions, among others. Furthermore, the money may be in various currencies and be exchanged using various exchange means and rates.

The vendor 192 and distributor 202 may be located in differing locations separated by geographic boundaries or political boundaries 198. The provider may have locations or contact points in one or many regions. For example, the political boundary 198 may be exemplified by the border between the United States of America (US) and Mexico. The provider 196 may have a contact point and phone number for Mexico 200 that interfaces with the provider systems in the US 196. A purchaser 194 may purchase with dollars a card from a vendor 192 in the US and provide the provider 196 with the information. The recipient 204 in Mexico may then receive pesos or an equivalent line of credit from a distributor 202 in Mexico. In this manner, money may be transferred to family, tourists, or business associates. Alternately, the money may establish a line of credit with a grocer, hotel, or manufacturing supplier, among others.

However, the boundary 198 may metaphorically represent the division between non-adjacent countries, states, or geographic boundaries, among others. Furthermore, various embodiments of the system 190 may be envisaged.

As such, a method and system for transferring money is described. In view of the above detailed description of the present invention and associated drawings, other modifications and variations will now become apparent to those skilled in the art. It should also be apparent that such other modifications and variations may be effected without departing from the spirit and scope of the present invention as set forth in the claims which follow.

1. A method for transferring money between a purchaser and a recipient, the method comprising:
vending a card to the purchaser, the card being associated with a denomination of a first currency, the card having a unique identification number;
providing a verification code, the verification code being associated with a vendor of the card;
receiving the unique identification number, the verification code, and recipient data from the purchaser; and
providing the recipient data to a distributor, the distributor distributing a monetary amount associated with the denomination of the first currency.

2. The method of claim 1 wherein the monetary amount comprises a line of credit.

3. The method of claim 1 wherein the monetary amount comprises an amount of a second currency.

4. The method of claim 1, the method further comprising:
providing to the purchaser data associated with the monetary amount associated with the denomination of the first currency.

5. The method of claim 1 wherein the step of receiving recipient data is performed via telephone.

6. The method of claim 1 wherein the step of providing the recipient data is performed via telephone.

7. The method of claim 1 wherein the recipient data comprises:
data associated with a means for verifying the identity of the recipient.

8. The method of claim 1 wherein the steps of receiving and providing the recipient data are associated with a voice recording.

9. The method of claim 1, the method further comprising:
collecting from the vendor of the card at least a monetary transfer amount associated with the denomination of the first currency.

10. The method of claim 1, the method further comprising:
providing to the distributor at least a monetary transfer amount associated with the denomination of the first currency.

11. A system for transferring money between a purchaser and a recipient, the system comprising:
a card having a unique identification number, the card being associated with a denomination of a first currency;
a verification number, the verification number being associated with a vending location, the verification number being indicative of a completed vending transaction;
a recipient data, the recipient data comprising data associated with a means for verifying the identity of the recipient;
a provider, the provider receiving the unique identification number, the verification number, and the recipient data from the purchaser, the provider providing the recipient data to a distributor; and
the distributor, the distributor verifying the identity of the recipient and providing a monetary amount associated with the denomination of the first currency.

12. The system of claim 11, the system further comprising:
a vendor, the vendor vending the card and providing the verification number to the purchaser.

13. The system of claim 11 wherein the monetary amount comprises an amount of a second currency.

14. The system of claim 11 wherein the monetary amount comprises a line of credit.

15. The system of claim 11 wherein the provider receives the unique identification number, the verification number, and the recipient data via telephone.

16. The system of claim 11 wherein the provider provides the recipient data to the distributor via telephone.

17. The system of claim 11 wherein the recipient data comprises a voice recording.

18. A method for transferring money from a purchaser to a recipient, the purchaser providing recipient data to a provider, the recipient data comprising data associated with a means of verifying the identity of the recipient, the provider providing to a distributor the recipient data and a monetary amount, the method comprising:
vending a card with a unique identification number, the card being associated with a denomination of a first currency; the vending being provided by a vendor; and
providing a verification number, the verification number being associated with the vendor, the verification number being indicative of the step of vending the card.

19. The method of claim 18, the method further comprising:
providing to the provider at least the monetary amount.

20. The method of claim 18, the method further comprising:
generating the verification number using data selected from the group consisting of the denomination, a vendor identification, a vendor location, a date of the step of vending, and the unique identification number.
